(19) United States
(12) Patent Application Publication
(10) Pub. No.: US 2009/0163666 A1
(43) Pub. Date: Jun. 25, 2009

(54) Polymer compositions exhibiting enhanced flow-induced crystallization

(76) Inventors: David John Lohse, Bridgewater, NJ (US); Cynthia A. Mitchell, Houston, TX (US); Michael Sansone, North Brunswick, NJ (US)

Correspondence Address: EXXONMOBIL RESEARCH AND ENGINEERING COMPANY, P.O. Box 900, Annandale, NJ, 08801-0900, US

(21) Appl. No.: 12/316,760

(22) Filed: Dec. 16, 2008

Related U.S. Application Data
(60) Provisional application No. 61/009,011, filed on Dec. 21, 2007.

(51) Int. Cl. C08L 9/00; C08L 23/06; B29C 47/00

(52) U.S. Cl. 525/232; 525/240; 264/176.1; 264/328.1; 264/172.11

(57) ABSTRACT

Provided is a polymer composition having a linear, semi-crystalline thermoplastic matrix polymer and a second thermoplastic polymer. The second polymer is a substantially saturated hydrocarbon polymer including (i) a backbone chain and (ii) one or more substantially hydrocarbon sidechains connected to the backbone chain. The sidechains each have a number-average molecular weight of from 2,500 g/mol to 125,000 g/mol and an MWD by SEC of 1.0 to 3.5. The mass ratio of sidechain molecular mass to backbone molecular mass is from 0.01:1 to 100:1. The matrix polymer is present at 95 wt % or more based on the weight of the composition. The second polymer is present at 0.2 to 5.0 wt % or more based on the weight of the composition. Provided is also a method for enhancing flow-induced crystallization in a linear, semi-crystalline thermoplastic matrix polymer. Provided is also a method for processing a polymer composition.

### CROSS-REFERENCE TO RELATED APPLICATIONS

This is a Non-Provisional Application that claims priority to U.S. Provisional Application 61/009,011 filed Dec. 21, 2007, which is herein incorporated by reference.

### FIELD

The present disclosure relates to compositions of semi-crystalline polymers that exhibit improved flow-induced crystallization.

### BACKGROUND

Products made from a semi-crystalline thermoplastic polymer, such as polyethylene or polypropylene, are often made by melting the polymer and then shaping it into a final form while the polymer cools. Examples of such processes include film blowing, film casting, injection molding, rotational molding, extrusion, blow molding, and melt-blown fiber formation.

Flow of molten polymer is known to induce crystallization, which is referred to as flow-induced crystallization. Since the time required for the relaxation of stresses in molten polymers is often much longer than for polymer solidification, crystallization typically occurs when the molecules (or at least some fraction of them) have not fully relaxed. Lack of relaxation increases the local ordering of the polymer chains, and so enables them to crystallize much more rapidly (by several orders of magnitude) than in stress-free conditions. In solidified articles, some degree of orientation or anisotropy will be frozen in. This also means that the mechanical properties of the article will be anisotropic, which is often a requirement for its fitness for use in a given application. Flow-induced crystallization is impacted by both molecular weight distribution (MWD) and long chain branching (LCB), since chains that are either very long or highly branched relax very slowly compared to short, linear ones.

Different methods have been attempted to enhance the degree of flow-induced crystallization. One method is to blend small amounts of high pressure low density polyethylene (HP-LDPE) into a linear matrix polymer, such as linear low density polyethylene (LLDPE). Another method is to significantly broaden the MWD of the matrix polymer by known techniques, such as multiple reactors and/or catalysts. Problems with the aforementioned methods are indirect control of flow-induced crystallization, possible negative impact on other desirable physical properties, and/or possible increase in economic costs.

It would be desirable to have a semi-crystalline polymer composition that exhibits enhanced flow-induced crystallization. It would also be desirable to have a method for enhancing flow-induced crystallization in a matrix polymer. It would further be desirable to have a method for processing a polymer composition in which flow-induced crystallization is enhanced.

### SUMMARY

According to the present disclosure, there is provided a polymer composition having a linear, semi-crystalline thermoplastic matrix polymer and a second thermoplastic polymer. The matrix polymer is present at 95 wt % or more based on the weight of the composition. The second polymer is a substantially saturated hydrocarbon polymer including (i) a backbone chain and (ii) one or more substantially hydrocarbon sidechains connected to the backbone chain. The sidechains each have a number-average molecular weight of from 2,500 g/mol to 125,000 g/mol and an MWD by SEC of 1.0 to 3.5. The mass ratio of sidechain molecular mass to backbone molecular mass is from 0.01:1 to 100:1. The second polymer is present at 0.2 wt % to 5 wt % or more based on the weight of the composition. There is also a method for enhancing flow-induced crystallization in a linear, semi-crystalline thermoplastic matrix polymer. Provided is also a method for processing a polymer composition.

Further according to the present disclosure, there is provided a method for enhancing flow-induced crystallization in a linear, semi-crystalline thermoplastic matrix polymer. The method has the step of blending into the matrix polymer an amount of 0.2 to 5 wt % of the second polymer described above.

Yet further according to the present disclosure, there is provided a method for processing a polymer composition, comprising extruding the matrix polymer in melt form and drawing it at a predetermined rate as it cools and solidifies. The matrix polymer is as described above. The second polymer is also described as above.

### BRIEF DESCRIPTION OF DRAWINGS

To assist those of ordinary skill in the relevant art in making and using the subject matter hereof, reference is made to the appended drawings, wherein:

FIG. 1 shows an illustration of a second polymer of comb configuration for the composition according to the present disclosure.

FIG. 2 shows an illustration of a second polymer of star configuration for the composition according to the present disclosure.

FIG. 3 shows 2D x-ray diffraction images of the sample of a LLDPE, a star polymer, and a comb polymer.

FIG. 4 is a 1D azimuthal plot of relative reflection intensity of the sample of LLDPE.

FIG. 5 is a 1D azimuthal plot of the sample of relative reflection intensity of the sample of 1% star polymer composition of the present disclosure.

FIG. 6 is a 1D azimuthal plot of the sample of relative reflection intensity of the sample of the 0.5% comb polymer composition of the present disclosure.

FIG. 7 is a plot showing the relative orientation of the samples of LLDPE, 1% star, and 0.5% comb as a function of drawdown rate.

FIG. 8 is a plot showing the azimuthal FWHM of the samples of LLDPE, 1% star, and 0.5% comb as a function of drawdown rate.

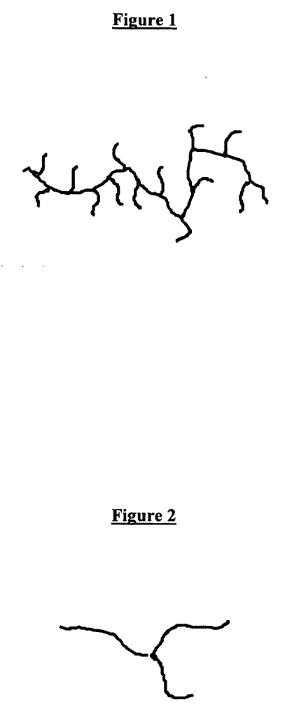

### DETAILED DESCRIPTION

In the present disclosure, relatively small amounts of a second polymer are added to relatively large amounts of a linear semi-crystalline primary or matrix thermoplastic polymer. The second polymer takes the form of a thermoplastic LCB or branched polymer having a comb-like or star-like molecular structure. The LCB polymer enhances the degree of relaxation of stresses during cooling, and, hence, the degree of orientation of the crystallized phase of the matrix polymer. The amount and structure of the LCB polymer can be configured to obtain end products with desirable physical and processing properties. All numerical values within the detailed description and the claims herein are understood as modified by “about.”

The primary or matrix polymer is a linear, semi-crystalline thermoplastic polymer. Useful classes of matrix polymers include homopolymers and copolymers of olefinic monomers, such as ethylene, propylene, butene, pentene, hexene, heptene, and octene. Useful homopolymers may include polyethylene and polypropylene. A preferred matrix polymer is linear low density polyethylene (LLDPE).

The matrix polymer is present in the composition at least 95 wt %, more advantageously 95 wt % to 99.8 wt %, and most advantageously 99 to 99.8 wt % based on the total weight of the composition.

The second (LCB) polymer is present in the composition is advantageously 5 wt % to 0.2 wt %, and most advantageously 1 wt % to 0.2 wt % based on the total weight of the composition.

When small amounts of second (LCB) polymer are added to compositions of linear matrix polymers, the degree of orientation of the resulting composition is increased relative to that of the linear matrix polymer alone. This increase in degree of orientation is observed with both star polymers and comb polymers. The level of increase is greater for the comb polymer relative to the star polymer. Thus, relatively smaller amounts of comb polymers can be employed to affect a desired degree of orientation relative to star polymers. Both star polymers and comb polymers are useful in matrix polymer compositions in the present disclosure.

The second (LCB) polymer takes the form of a substantially saturated hydrocarbon polymer having: A) a backbone chain, B) one or more essentially hydrocarbon sidechains connected to A), wherein the sidechains each have a number-average molecular weight of from 2.5 kg/mol to 125 kg/mol and an MWD by SEC of 1.0 to 3.5, and C) a mass ratio of sidechains molecular mass to backbone molecular mass of from 0.01:1 to 100:1. The second polymer advantageously has the following physical properties: A) a Newtonian limiting viscosity η₀ at 190° C. of at least 50% greater than that of a linear olefinic polymer of the same chemical composition and weight average molecular weight and more advantageously at least twice as great as that of the linear polymer, B) a ratio of the rubbery plateau modulus at 190° C. to that of a linear polymer of the same chemical composition less than 0.5 and more advantageously less than 0.3, C) a ratio of the Newtonian limiting viscosity η₀ to the absolute value of the complex viscosity in oscillatory shear η* at 100 rad/sec at 190° C. of at least 5, and D) a ratio of the extensional viscosity measured at a strain rate of 1 sec⁻¹, 190° C., and time=3 seconds (i.e., a strain of 3) to that predicted by linear viscoelasticity at the same temperature and time of 2 or greater.

The second polymer can also be described as those having a main, or backbone chain, of ethylene and other insertion copolymerizable monomers, containing one or more randomly distributed side chains of ethylene and other insertion copolymerizable monomers. The backbone chain has a weight-average molecular weight from 5,000 to 1,000,000 g/mol, advantageously from 10,000 to 500,000 g/mol, and most advantageously from 20,000 to 200,000 g/mol. The side chains have weight-average molecular weights from 2,500 to 125,000 g/mol, advantageously from 3,000 to 80,000 g/mol, and most advantageously from 4,000 to 60,000 g/mol. As expressed in Mₑ^{B}, side chains have weight-average molecular weights ranging from 2 to 100 times the entanglement weight of copolymer, advantageously 3 to 70 times the entanglement weight of copolymer, and most advantageously 4 to 50 times the entanglement weight of copolymer. The number of side chains per backbone chain is determined by the average spacing between the branches, the backbone segment between each branch averaging a weight average of at least twice the entanglement molecular weight of polyethylene, advantageously 3 to 25 times the entanglement molecular weight of polyethylene. In practice, this establishes a number of arms of from 2 to 100, advantageously 2 to 70, most advantageously 3 to 50. The MWD, defined as the ratio of weight-average molecular weight to number-average molecular weight, for both the backbone chain and the sidechains, independently, can be from 1.0 to 6, advantageously 1 to 5, and most advantageously 1 to 3.5.

One method for making the second (LCB) polymer is through the saturation of anionically synthesized polydienes. Various polydienes can be saturated to give structures that are identical to polyolefins as was reported by Rachapudy, H.; Smith, G. G.; Raju, V. R.; Graessley, W. W.; J. Polym. Sci.-Phys. 1979, 17, 1211. The polydiene is completely saturated with substantially no side reactions that might degrade or crosslink the molecules. The controlled molecular weight and structure available from anionic polymerization of conjugated dienes are thus preserved. A unit of butadiene that has been incorporated 1, 4 into the polybutadiene chain will have the structure of two ethylenes (four methylenes) after saturation, and those that go in as 1, 2 will be like one butene unit. So the saturated versions of polybutadienes of a range of microstructures are identical in structure to a series of ethylene-butene copolymers. Similarly saturated polyisoprenes resemble an alternating ethylene-propylene copolymer, and other polydienes can give the structures of polypropylene and other polyolefins upon saturation. A wide variety of saturated hydrocarbon polymers can be made in this way.

Thus, linear ethylene-butene copolymers can be made by the saturation of linear polybutadienes and linear ethylene-propylene copolymers can be made by the saturation of linear polyisoprenes. The linear polymers can be prepared by anionic synthesis on a vacuum line in accordance with the teachings of Morton, M.; Fetters, L. J.; Rubber Chem. & Technol. 1975, 48, 359. The polymers made in this manner were prepared in cyclohexane at 0° C. with butyllithium as initiator. The polydiene polymers were then saturated under H₂ pressure using a Pd/CaCO₃ catalyst of J. Polym. Sci.-Phys. 1979, 17, 1211 (above). This technique can be used to make polymers over a wide range of molecular weights, e.g., polymers with molecular weights from 3,500 g/mol to 800,000 g/mol.

The second (LCB) polymers can be made by attaching one or more linear polymers, prepared as described above, as branches to another of the linear polymers serving as a backbone or main chain polymer. The general method is to produce branch or arm linear polymers by the procedure above, using the butyllithium initiator; this produces a polybutadiene with a lithium ion at the terminal end. A linear backbone is made in the manner described above with some number of the pendant vinyl double bonds on the backbone polymers which are then reacted with (CH₃)₂SiClH using a platinum divinyl tetramethyl disiloxane catalyst. The lithium ends of the arm polybutadiene polymers are then reacted with the remaining chlorines on the backbone polybutadiene vinyls, attaching the arms. Because both the placement of the vinyl groups in the backbone and the hydrosilylation reaction are random, so is the distribution of arms along and among the backbone molecules. The polybutadiene combs can be saturated as shown above to form ethylene-butene copolymer combs with nearly monodisperse branches randomly placed on a nearly monodisperse backbone. Polymers having two branches can be made by a similar synthetic procedure. Four anionically synthesized polymers (arms) are attached to the ends of a separately synthesized polymer (“connector”), two at each end. This results in an H-shaped structure, i.e., a symmetric placement of the arms and non-random distribution of the arms of the molecule.

An alternate method of preparing the branched olefin copolymers of the disclosure, particularly ethylene copolymers, is by preparing olefinically unsaturated macromers having molecular weight attributes within that described for the branch or arm polymers or copolymers and incorporating those into a branched polymer by copolymerization. Such can be done, for example, by preparing branched macromers from olefins such that there is vinyl or vinylidene unsaturation at or near the macromer chain end. Such macromers are known in the art and the use of metallocenes to prepare them and then to insert or incorporate them into a forming polymer as long chain branches. Branched macromers can be prepared by series reactions or in situ single processes in which the selection of catalyst or catalyst mix allows for the preparation of olefinically unsaturated macromers and subsequent incorporation of them into forming polymeric chains. U.S. Pat. No. 5,324,800 and WO 94/07930 disclose such branched macromers and processes for making and are incorporated herein by reference in their entirety.

To ensure the quality and a desirable number of branches, it is suitable to use a multistep reaction process wherein one or more branch macromers are prepared and subsequently introduced into a reaction medium with a catalyst capable of coordination copolymerization of both the macromer and other coordination polymerizable monomers. The macromer preparation advantageously is conducted so as to prepare narrow MWD macromers, e.g., 2.0 to 3.5, or even lower when polymerization conditions and catalyst selection permit. The comonomer distribution can be either narrow or broad, or the macromer can be a homopolymeric macromer. The use of essentially single site catalysts, such as metallocene catalysts, permits selection of a narrow MWD. Branch separation, or, stated alternatively, branch numbers by molecular weight of the backbone chain, is typically controlled by ensuring that the reactivity ratios of the macromers to the copolymerizable monomers is at a ratio that allows the preferred ranges for the branch structure as described above. Such can be determined empirically within the skill in the art. Factors to be adjusted include catalyst selection, temperature, pressure, and time of reaction, and reactant concentrations, all as is well-known in the art.

In this manner, branched copolymers are made directly without hydrogenation and the selection of comonomers is extended to the full extent allowed by insertion or coordination polymerization. Useful comonomers include ethylene, propylene, 1-butene, isobutylene, 1-hexene, 1-octene, and higher alpha-olefins; styrene, cyclopentene, norbornene, and higher carbon number cyclic olefins; alkyl-substituted styrene or; alkyl-substituted norbornene; ethylidene norbornene, vinyl norbornene, 1,4-hexadiene, and other non-conjugated diolefins. Such monomers can be homopolymerized or copolymerized, with two or more copolymerizable monomers, into either or both of the branch macromers or backbone chains along with the macromers.

The polymer compositions of the present disclosure are useful in conventional processing techniques or methods, such as injection molding, extrusion, fiber spinning, and film blowing.

Additional teachings directed to the composition, physical characteristics, and techniques for making the second (LCB) polymer are disclosed in U.S. Pat. Nos. 6,355,757 B2 and 6,417,281 B2, both of which are incorporated herein in their entirety.

The following are examples of the present disclosure and are not to be construed as limiting.

### EXAMPLES

### Example 1

Various LCB polymers are introduced in linear polymers and the resulting blends analyzed for flow-induced crystallization via in-situ x-ray diffraction. The linear matrix is a linear low density polyethylene (LLDPE), Exceed 1012 by ExxonMobil Chemical Co. The LLDPE is an ethylene-hexene copolymer with a density of 0.912 g/cc and melt index (MI) of 1. The LCB polymers are all derived from the anionic polymerization of butadiene, followed by hydrogenation to yield a basic chain structure identical to an ethylene-butene copolymer with 8 wt % butene based on the total weight of the copolymer. Anionic chemistry allows us to make samples that are nearly monodisperse, with M_{w}/Mₙ<1.1, and also is compatible with coupling chemistry to make very precise branched structures. For example, a comb-like molecule can be made by adding several equal length chains onto the backbone of another chain. Here we have used sample PECOM-B, which has a backbone with M_{w}=97 kg/mol and on the average four arms of M_{w}=36 kg/mol.

Our initial objective is to experimentally examine flow-induced crystallization of Exceed 1012, and then monitor changes when small amounts of PECOM-B are added. The extruder used is a special extruder system that allows the researcher to utilize a focused x-ray beam produced by a synchrotron to directly investigate the crystallization of a fiber or film as it exits from an extruder. The high x-ray brilliance enables the characterization of extremely small diffraction volumes and the detection of early and intermediate stages of crystallization. The beamline was configured for 13 kev x-ray operations with a spot size of 0.2 mm (horizontal) by 0.2 mm (vertical). A Bruker CCD camera system was used to collect 2D x-ray diffraction data. The extruder is an American Kuhne single screw extruder with a 1-inch diameter screw. The extruder sits above the x-ray beam line and a variable speed take-up spool system below it, so that the extruded fiber or film (the form of the extrudate depending on the shape of the die—capillary, spinneret, or cast film) passes through the x-ray beam. Precision guide roller stages are used to position the fiber in the x-ray beam. By physically raising or lowering the extruder with respect to the x-ray beam, one can interrogate the fiber or film at various distances from the die, and therefore at various stages of extensional flow crystallization associated with extrudate cooling. The experimental apparatus also includes a video system to measure the fiber diameter and IR optics to measure the fiber surface temperature.

Stress-induced crystallization is qualitatively different from quiescent solidification. With the current experimental apparatus, the evolution of flow-induced crystallization with respect to short and long-range order/orientation of crystallization can be studied via application of wide-angle x-ray scattering (WAXS) and small-angle x-ray scattering (SAXS). In particular, initiation of crystallization can be precisely identified and its dependency on such factors as extrusion rate, take-up speed, melt temperature, cooling rates and polymer architecture. Also, the orientation of the crystals is an important determinant, since the physical properties (especially the anisotropy of such properties) will depend on the final orientation.

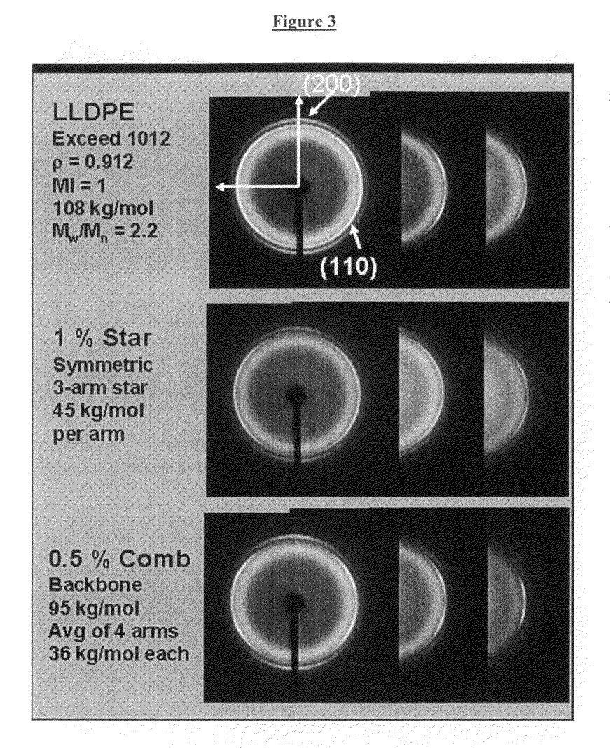

The degree of orientation can be clearly seen in the 2D x-ray diffraction images from the fibers. In these experiments, the anisotropy of the (110) reflection from the crystals is used as a measure of orientation. If the crystals have no preferred orientation, then the WAXS pattern shows a complete circular arc for the (110) reflection. As the crystals orientate along the fiber axis, the more the (110) reflections will be azimuthally localized nearer to the equator of the image. The angular degree to which the peak in the (110) reflection is off the equator is an important crystal orientation indicator. This can be visualized in the images in FIG. 3, which shows the WAXS scattering patterns for pure Exceed 1012 (LLDPE), for the 99/1 Exceed 1012/PESTAR-B blend, and for the 99.5/0.5 Exceed 1012/PECOM-B blend at three different drawdown rates (increasing from left to right).

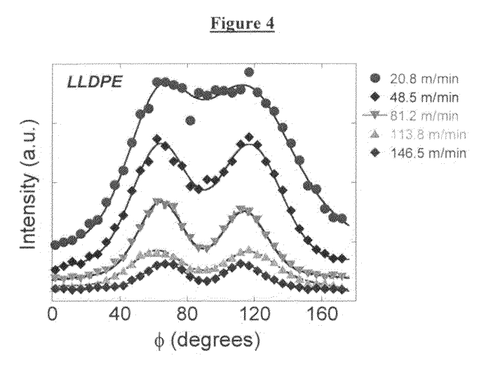

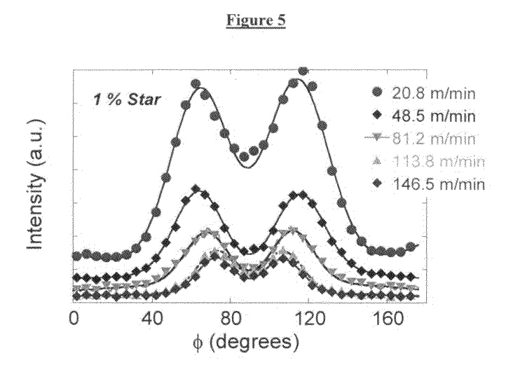

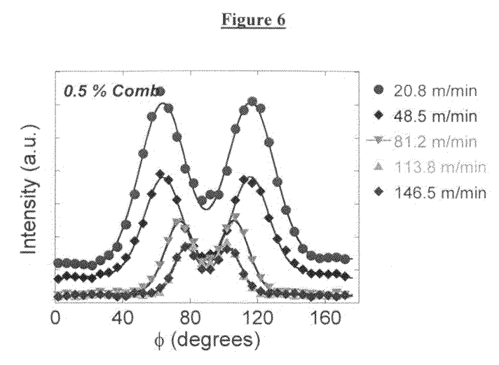

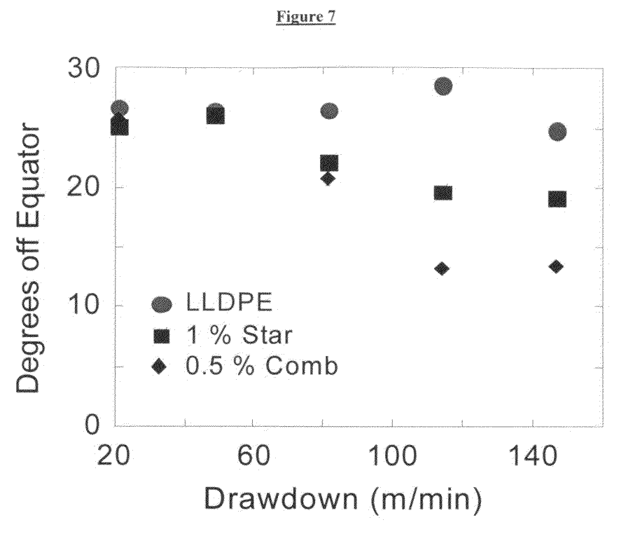

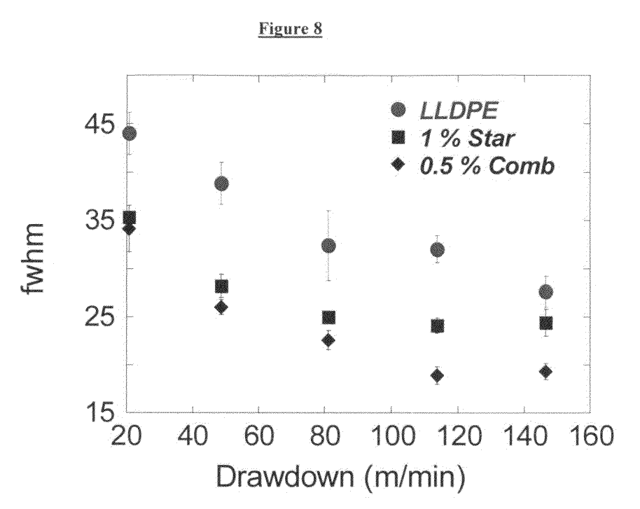

The 1D azimuthal plots of the (110) reflection for the matrix (LLDPE) and the 0.5% comb blend are shown in FIGS. 4 and 5. Enhanced orientation is indicated by reflections localized nearer the equator and a narrowing of the azimuthal FWHM (full width at half maximum). As drawdown is increased, the position of the (110) reflection moves toward the equator and the azimuthal FWHM narrows, which is indicative of increasing orientation. Also, at higher drawdown rates, fiber diameter decreases, which reduces the x-ray diffraction volume and consequently the relative reflection intensity. Clearly, the presence of LCB enhances orientation in flow-induced crystallization, but the largest effect is exhibited by LLDPE with just 0.5 wt % of comb material indicating orientation is influenced not only by concentration but also by the architecture of the chains. These trends are illustrated graphically in FIGS. 6 and 7. FIG. 6 is a plot showing degrees of equator of the (11) arc as a function of drawdown. As crystal orient along the fiber axis, the (110) azimuthal arcs move closer to the equator. FIG. 7 is a plot showing the FWHM of the (11) azimuthal peak as a function of drawdown. As more crystal orient along the fiber axis, the azimuthal FWHM narrows, which indicates increasing orientation.

During extrusion, it is clear that crystals orient to a much greater degree the faster the fiber is pulled. However, it can be seen that the degree to which the drawdown rate effects the orientation can be greatly altered by the addition of small amounts (0.5-1%) of the LCB polymers. Surprisingly, this effect strongly depends on the type of branching. 0.5% of the multiply-branched comb (PECOM-B) has greatly enhanced the orientation of the crystals. A similar, but less dramatic, effect is given by adding 1.0% of PESTAR-B. These results demonstrate that precise tailoring of both the level and type of LCB in a polymer can lead to dramatic effects on the orientation of its crystals and thereby modify its physical properties and performance.

### Example 2

### PECOM-A

Comb polybutadiene (COM-A) was prepared by coupling hydrosilylated polybutadiene (Mₙ=106 kg/mol by size exclusion chromatography (SEC); 10% 1,2 units; BB_{A}) with polybutadienyllithium (PBdLi, Mₙ=6.4 kg/mol by SEC; T_{A}). The polybutadiene which was used as backbone (BB_{A}) for the hydrosilylation reaction was prepared by anionic polymerization using high vacuum techniques, with sec-BuLi in benzene at room temperature. 1.5 grams of BB_{A} were dissolved in 40 ml tetrahydrofuran (THF) in a one-liter round bottom flask equipped with a good condenser, to which 3 drops of platinum divinyl tetramethyl disiloxane complex in xylene (catalyst, Petrarch PC072) were added. The solution was dried overnight with 0.5 ml trimethylchlorosilane, followed by the addition of 1.41 mmole dimethylchlorosilane. The mixture's temperature was raised slowly to 70° C. Changing of the color, vigorous boiling and refluxing indicated the start of the reaction which was continued for 24 hours at 70° C. THF and chlorosilane compounds were removed in the vacuum line by heating the polymer at 45° C. for 5 days. The polymer was dissolved in benzene and sealed under vacuum. 10% of the BB₁ was converted to insoluble gel. Living PBdLi (T_{A}) used for the coupling reaction was prepared in the same manner as BB_{A}. The synthesis of T_{A} was performed by reacting 12.75 grams of monomer with 2.550 mmoles of initiator. Prior to the coupling reaction 1 gram of T_{A} was removed, terminated with methanol and used for characterization. 20% excess of T_{A} was used for the coupling reaction, which was monitored by SEC and allowed to proceed for 2 weeks. Excess T_{A} was terminated with methanol. The comb polymer was protected against oxidation by 2,6-di-tert-butyl-p-cresol and was fractionated in a toluene-methanol system. Fractionation was performed until no arm or undesirable products were shown to be present by SEC. The comb was finally precipitated in methanol containing antioxidant, dried and stored under vacuum in the dark. Characterization, which was carried out by SEC, membrane osmometry (MO), vapor pressure osmometry (VPO), low-angle laser light scattering (LALLS), and laser differential refractometry, indicated the high degree of molecular and compositional homogeneity. By MO and VPO, the Mₙ of COM-A was 274 kg/mol. The number of arms experimentally obtained was thus calculated to be 34, indicating that only 38% of the T_{A} arms reacted during the hydrosilylation step.

The resulting comb PBd (COM-A) was saturated catalytically. 3 grams of COM-A were dissolved in cyclohexane and reacted with H₂ gas at 90° C. and 700 psi in the presence of 3 g of a catalyst made by supporting Pd on CaCO₃. The reaction was allowed to proceed until the H₂ pressure stopped dropping, or 24 h. The polymer solution was then filtered to remove the catalyst residues. The saturation of the polymer was seen to be greater than 99.5% by proton NMR. The M_{w} of the resulting saturated polymer (PECOM-A) was measured as 290 kg/mol by LALLS.

### Example 3

### PECOM-B

The synthesis of PECOM-B proceeded in a manner similar to that for PECOM-A in Example 1, except that it was made in much larger quantities and was not fractionated prior to hydrogenation. The backbone polybutadiene (BBB) had Mₙ=94.1 kg/mol by SEC, while for the arms (T_{B}) Mₙ=36 kg/mol by SEC. Only a small portion of this polymer was fractionated (fro analysis purposes), and the whole polymer (PBD COM-B) had Mₙ=239.1 kg/mol by MO, indicating 4 arms per backbone. The great majority of the polymer was not fractionated before hydrogenation, and resulting in 78 grams of PECOM-B, a mixture with 50% of the well-defined comb, and 50% of the unattached arms.

### Example 4

### PESTAR-A

The synthesis of this star with three equal length arms was performed by using the linking agent (trichloromethylsilane) as above. 15 grams of butadiene were reacted with 0.300 mmoles of initiator in 350 ml of benzene and a PBd (A₃) with Mₙ=43 kg/mol by SEC was obtained. 1 gram was removed before the linking reaction for characterization purposes. 0.075 mmoles of trichloromethylsilane were used in order to have a 20% excess of the arm. The progress of the reaction was monitored by SEC and was left to proceed for 3-4 weeks. Fractionation and molecular characterization was accomplished with the manner described in Example 1, and the polymer was hydrogenated as also described in Example 1. The resulting saturated polymer had an M_{w} of 133 kg/mol by LALLS.

### Example 5

### PESTAR-B

The synthesis of this star shaped polymer proceeded in a similar manner to that of Example 4, except in a much larger quantity. The polybutadiene arms of this polymer had Mₙ=48 kg/mol by SEC, while for the whole saturated polymer M_{w}=142 kg/mol by LALLS. 550 g of the final product were made.

Applicants have attempted to disclose all embodiments and applications of the disclosed subject matter that could be reasonably foreseen. However, there may be unforeseeable, insubstantial modifications that remain as equivalents. While the present disclosure has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated.

What is claimed is:

1. A polymer composition, comprising:
a) a linear, semi-crystalline thermoplastic matrix polymer, wherein the matrix polymer is present at 95 wt % or more based on the weight of the composition, and
b) 0.2 to 5.0 wt % of a second thermoplastic polymer, wherein the second polymer is a substantially saturated hydrocarbon polymer including (i) a backbone chain and (ii) one or more substantially hydrocarbon sidechains connected to the backbone chain, wherein the sidechains each have a number-average molecular weight of from 2,500 g/mol to 125,000 g/mol and an MWD by SEC of 1.0 to 3.5, and wherein the mass ratio of sidechain molecular mass to backbone molecular mass is from 0.01:1 to 100:1.

2. The composition of claim 1, wherein the matrix polymer is a linear low density polyethylene.

3. The composition of claim 1, wherein the second polymer is an ethylene/butene copolymer.

4. The composition of claim 1, wherein the second polymer is hydrogenated polybutadiene.

5. The composition of claim 1, wherein the matrix polymer is present in the composition at 99 wt % to 99.8 wt % and the second polymer in the composition is present 1 wt % to 0.2 wt % based on the total weight of the composition.

6. A method for enhancing flow-induced crystallization in a linear, semi-crystalline thermoplastic matrix polymer, comprising blending into the matrix polymer an amount of 0.2 to 5.0 wt % of a second thermoplastic polymer of a substantially saturated hydrocarbon polymer including (i) a backbone chain and (ii) one or more of substantially hydrocarbon sidechains connected to the backbone chain, wherein the sidechains each have a number-average molecular weight of from 2,500 g/mol to 125,000 g/mol and an MWD by SEC of 1.0 to 3.5, and wherein the mass ratio of sidechain molecular mass to backbone molecular mass is from 0.01:1 to 100:1.

7. The method of claim 6, wherein the matrix polymer is a linear low density polyethylene.

8. The method of claim 6, wherein the second polymer is an ethylene/butene copolymer.

9. The method of claim 6, wherein the second polymer is a hydrogenated polybutadiene.

10. The method of claim 6, wherein the matrix polymer is present in the composition at 99 wt % to 99.8 wt % and the second polymer in the composition is present 1 wt % to 0.2 wt % based on the total weight of the composition.

11. A method for processing a polymer composition, comprising extruding a polymer composition of a matrix polymer and a second polymer in melt form and drawing it at a predetermined rate as it cools and solidifies, wherein the matrix polymer is a linear, semi-crystalline thermoplastic matrix polymer, wherein the second polymer is a substantially saturated hydrocarbon polymer including (i) a backbone chain and (ii) one or more substantially hydrocarbon sidechains connected to the backbone chain, wherein the sidechains each have a number-average molecular weight of from 2,500 g/mol to 125,000 g/mol and an MWD by SEC of 1.0 to 3.5, and wherein the mass ratio of sidechain molecular mass to backbone molecular mass is from 0.01:1 to 100:1.

12. The method of claim 11, wherein the matrix polymer is a linear low density polyethylene.

13. The method of claim 11, wherein the second polymer is an ethylene/butene copolymer.

14. The method of claim 11, wherein the second polymer is a hydrogenated polybutadiene.

15. The method of claim 11, wherein the matrix polymer is present in the composition at 99 wt % to 99.8 wt % and the second polymer in the composition is present 1 wt % to 0.2 wt % based on the total weight of the composition.

16. A method for processing the polymer composition of claim 1, comprising subjecting the polymer composition to a process selected from the group consisting of injection molding, extrusion, fiber spinning, and film blowing.
